(19) United States
(12) Patent Application Publication
(10) Pub. No.: US 2025/0091275 A1
(43) Pub. Date: Mar. 20, 2025

(54) INTERRUPTIBLE SHEAR-ASSISTED EXTRUSION

(71) Applicant: Battelle Memorial Institute, Richland, WA (US)

(72) Inventors: Scott A. Whalen, West Richland, WA (US); Brandon Scott Taysom, West Richland, WA (US); Md. Reza-E-Rabby, West Richland, WA (US)

(21) Appl. No.: 18/410,784

(22) Filed: Jan. 11, 2024

Related U.S. Application Data
(60) Provisional application No. 63/539,493, filed on Sep. 20, 2023.

(51) Int. Cl. B29C 48/14; B29C 48/00; B29C 48/25

(52) U.S. Cl. CPC B29C 48/146; B29C 48/022; B29C 48/002; B29C 48/2513; B29C 2948/92209; B29C 2948/92523

(57) ABSTRACT

A shear-assisted extrusion process and related apparatus can include establishing shear-assisted extrusion to form a first extrudate, suspending such extrusion, and re-starting extrusion with the same material or initiating extrusion of a different material or different billet of the same material to form a second extrudate, without requiring disassembly of extrusion apparatus or clearing of an extrusion die tool. A resulting combined extrudate can include a fused region joining the first extrudate and the second extrudate. Such processing does not require (nor generally involve) melting of feedstock materials and can be performed even if cooling occurs of the die tool and associated billet material between suspension of extrusion and re-start or initiation of subsequent extrusion. In this manner, downtime can be reduced or minimized, or extrusions can be formed having different material properties along their axial extent, as illustrative examples.

### CROSS REFERENCE TO RELATED APPLICATION

This application claims priority to and the benefit of U.S. Provisional Application Ser. No. 63/539,493 filed on Sep. 20, 2023, the contents of which are hereby incorporated by reference.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### TECHNICAL FIELD

This document pertains generally, but not by way of limitation, to solid-phase processing of materials for extrusion applications, and more particularly to techniques and related apparatus for performing shear-assisted extrusion on an interruptible basis.

### BACKGROUND

Metal extrusion is a metal-forming manufacturing process in which a cylindrical billet inside a closed cavity is forced to flow through a die aperture. These extruded parts are called “extrudates.” The process was first used to extrude lead pipes. In addition to metals, plastics and ceramics can also be extruded.

### SUMMARY

Extrusion generally refers to a process where a feedstock material, such as a billet or puck, is forced axially through an opening of a die to form an extrusion. In a non-shear-assisted approach, if the billet or puck is heated to perform such extrusion, and processing is interrupted, it is generally not feasible to re-start extrusion relying on the heat generated by the extrusion process itself, such as after cool-down. For example, if the feedstock material comprises a metal, such a metal can harden within the die, and the die cannot generally be re-heated to a suitable extrusion temperature by the mechanical force of the extrusion process itself without the need for externally applied heat such as resistance heating or induction heating.

The present inventors have recognized, among other things, that using a shear-assisted extrusion process (e.g., “Shear Assisted Processing and Extrusion” or ShAPE), where axial and shear forces are established at an interface between the die and a feedstock, heat will be generated and such heating can plasticize the materials in or around the die face and opening, such as enabling interruption and re-start of extrusion without requiring clearing of the die or other operations. Such interruption and re-initiation of extrusion or “stop/start” can support planned or unplanned suspension of extrusion. For example, being able to stop and restart can facilitate replenishment of feedstock material without requiring a complete tear-down or cleaning of the die or can facilitate formation of extrudates having different material properties or composition along their axial extent, as illustrative examples.

A shear-assisted extrusion process and related apparatus can include establishing shear-assisted extrusion to form a first extrudate, suspending such extrusion, and re-starting extrusion with the same material or initiating extrusion of a different billet of the same or different material to form a second extrudate portion, without requiring disassembly of extrusion apparatus or clearing of an extrusion die tool. Further, the suspension and re-starting can allow for raising the temperature of the billet (due to the rotational and axial forces) after cooling has occurred due to the interruptions. A resulting combined extrudate can include a fused region joining the first extrudate and the second extrudate. Such processing does not require external pre-heating of feedstock materials and can be performed even if cooling of the die tool and associated billet material occurs between suspension of extrusion and re-start or initiation of subsequent extrusion. Because of the self-heating nature of shear-assisted extrusion, an ability to stop and re-start without complete or partial teardown means that downtime can be reduced or minimized or extrusions can be formed having different material properties along their axial extent, as illustrative examples.

For example, aluminum alloy 6063 is shown as a feedstock for interruptible ShAPE processing, where the apparatus and techniques shown in such examples illustrate capability of re-starting extrusion after the process is interrupted, such as where a die is retracted from a billet, and the die, billet, and extruded material are allowed to cool or cool significantly or to about ambient (e.g., room) temperature. Use of AA 6063 is illustrative, and the techniques shown and described herein, are believed applicable to other materials, such as other metals or alloys thereof that can be extruded by the shear-assisted (e.g., ShAPE) process. With shear-assisted processing, heat generated by rotation of a die relative to the feedstock material can re-heat the die set and feedstock so the extrusion can proceed after stopping and cooling. In this manner, application of heat to the tooling or feedstock materials in advance of shear-assisted processing is not required. A rate of heat generation can be controlled by modifying one or more of a rotational speed, rotational torque, rotational power, axial speed, or axial force. Feedback can be provided such as by monitoring a temperature at or near an interface between a die tool and a feedstock material or within the die distally removed from the die face. Such feedback can be used to avoid problematic temperature ranges such as incipient melting, such as to maintain or enhance an ability to generate heat frictionally (e.g., avoiding transitioning of a feedstock from a solid phase to a liquid or melted phase). A thermocouple can be used to monitor the temperature in a weld chamber where the feedstock material is extruded into to make sure the extruded feedstock material is warm enough to re-extrude. Generally, shear-assisted extrusion includes a rotating component and a structure to apply force between a face of a rotating component and another element. For example, the rotating component can include a die tool, and the other element can include an end or face of a feedstock in the form of a billet or briquette, where the rotating component includes a scroll define protrusions or channels. Friction between the rotating component and a stationary end of the feedstock (or vice versa) and deformation of the feedstock generates heat, which is increases the temperature of the billet (at least locally near the face) and tooling to a sufficient temperature to soften material within the die to enable the extrusion process to initiate, such as after an interruption such as a work stoppage, tool change, or material replenishment. Such flexibility and re-start capability can reduce non-productive time, such as allowing a shorter duration to achieve steady-state operation. In addition, or instead, the apparatus and techniques described herein can be used to reduce or eliminate material waste, because material need not be sacrificed (or less material can be wasted) in response to interruption of extrusion or in relation to feedstock replenishment.

As illustrative examples, a capability to stop and start an extrusion process provides cost saving associated with one or more of increased production capacity, energy savings, or reduction in labor and capital, as compared to non-shear-assisted extrusion, where non-shear-assisted extrusion techniques generally lack such stopping and starting capability, without teardown or die replacement. As another example of a challenge that can be addressed by the present subject matter, non-shear-assisted approaches generally involve both billet and tool change (e.g., to clear the extrusion processing equipment of partially-extruded material that may be fouling the tooling), such as when downstream operations experience delays. A time duration associated with such delays can significantly reduce the overall throughput associated with extrusion operation. As another illustrative example of challenge that can be addressed by the present subject matter, in non-shear-assisted extrusion, processing generally involves that both billet and tooling be preheated and maintained at elevated temperature to facilitate billet or tool changeover when an extrusion stoppage occurs, such as when extrusion must be halted due to stoppage in downstream operations.

The approaches described herein need not use such preheating or constant externally-applied heating, resulting in lower energy consumption as compared to non-shear-assisted processing. Avoidance or reduction of preheating can also reduce capital expenditure by reducing or eliminating a need for associated ovens or other facilities to perform such heating. In yet another example of a challenge that can be addressed by the present subject matter, elimination or reduction of tool change-out or other maintenance associated with extrusion stoppage can reduce a burden on skilled maintenance or technical staff, such as reducing or eliminating a need for such staff to be standing by in the case of unexpected interruption.

### BRIEF DESCRIPTION OF THE DRAWINGS

In the drawings, which are not necessarily drawn to scale, like numerals may describe similar components in different views. Like numerals having different letter suffixes may represent different instances of similar components. Various embodiments are illustrated by way of example in the figures of the accompanying drawings. Such embodiments are demonstrative and not intended to be exhaustive or exclusive embodiments of the present subject matter.

FIG. 1 illustrates, by way of example and not limitation, a section view of system for extruding a structure having a hollow cross section.

FIG. 2 illustrates, by way of example and not limitation, a section view of system for extruding a structure having a hollow cross section.

FIG. 3A illustrates, by way of example and not limitation, an oblique top view of a porthole die showing a modified scroll face.

FIG. 3B illustrates, by way of example and not limitation, an oblique bottom view of the porthole die showing portholes and a mandrel.

FIG. 4 illustrates, by way of example and not limitation, a section view of a portion of a system including a die tool and a billet system for extruding a structure having a hollow cross section.

FIG. 5 illustrates, by way of example and not limitation, a section view of a portion of a system including an extruded structure having a hollow cross section.

FIG. 6 illustrates, by way of example and not limitation, a section view of a portion of a system including an extruded structure and a billet container.

FIG. 7 illustrates, by way of example and not limitation, a section view of a portion of a system including an extruded structure and an inserted billet.

FIG. 8 illustrates, by way of example and not limitation, a system for extruding a structure having a hollow cross section, formed from two billets.

FIG. 9A illustrates, by way of example and not limitation, an extruded structure formed from two billets.

FIG. 9B illustrates, by way of example and not limitation, an extruded structure having a circular, hollow cross section.

FIG. 9C illustrates, by way of example and not limitation, an extruded structure having an approximately square, hollow cross section.

FIG. 9D illustrates, by way of example and not limitation, an extruded structure having an approximately trapezoidal, hollow cross section.

FIG. 9E illustrates, by way of example and not limitation, an example extruded structure having an approximately trapezoidal exterior shape, hollow, and cross-braced cross section.

FIG. 10A illustrates, by way of example and not limitation, a graph of a comparison of speed, power, and torque during an extrusion process.

FIG. 10B illustrates, by way of example and not limitation, a graph of axial force over time during an extrusion process.

FIG. 10C illustrates, by way of example and not limitation, a graph of axial speed over time during an extrusion process.

FIG. 10D illustrates, by way of example and not limitation, a graph of tool temperature over time during an extrusion process.

FIG. 11A illustrates, by way of example and not limitation, a graph of a comparison of speed, power, and torque during an extrusion process.

FIG. 11B illustrates, by way of example and not limitation, a graph of axial force over time during an extrusion process.

FIG. 11C illustrates, by way of example and not limitation, a graph of axial speed over time during an extrusion process.

FIG. 11D illustrates, by way of example and not limitation, a graph of tool temperature over time during an extrusion process.

FIG. 12 illustrates, by way of example and not limitation, a method for interruptible shear-assisted extrusion.

FIG. 13 illustrates, by way of example and not limitation, a method for interruptible shear-assisted extrusion.

### DETAILED DESCRIPTION

Shear assisted extrusion processes (ShAPE) are provided, such as for forming an extrudate on an interruptible basis. The shear assisted extrusion processes can include providing axial and shear forces established at an interface between a die and a feedstock, where heat will be generated, and such heating can plasticize the materials in or around the die face and opening. The heating generated by the extrusion process itself, and resulting plasticization, can enable interruption and re-starting of the extrusion without requiring clearing of the die or other operations. Such interruption and re-initiation of extrusion or “stop/start” can support planned or unplanned suspension of extrusion. For example, being able to stop and restart can facilitate replenishment of feedstock material without requiring a complete tear-down, replacement, or cleaning of the die, or can facilitate formation of extrudates having different material properties or composition along their axial extent, as described herein.

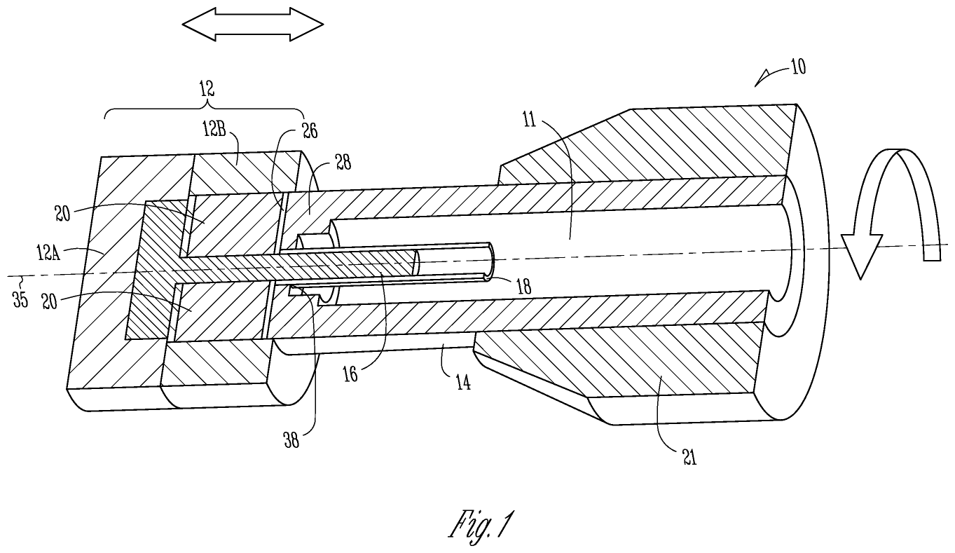

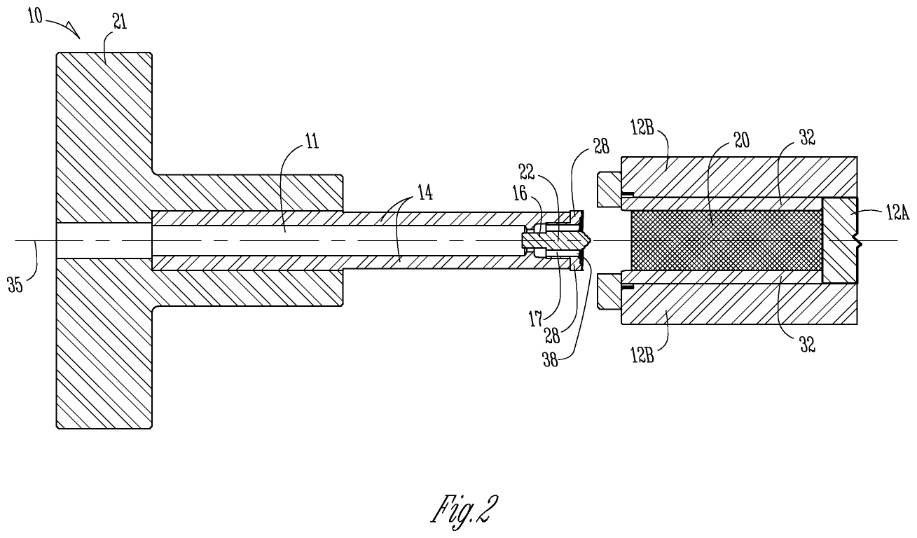

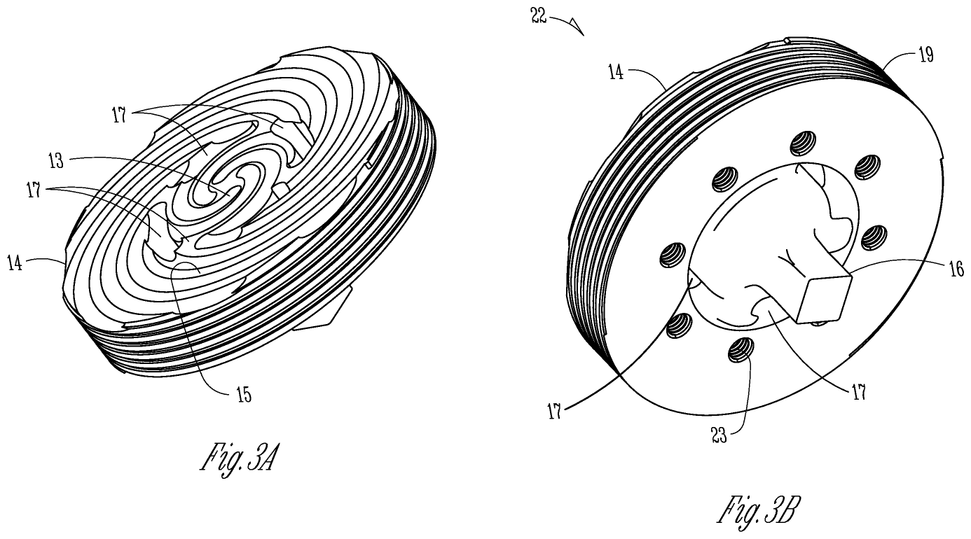

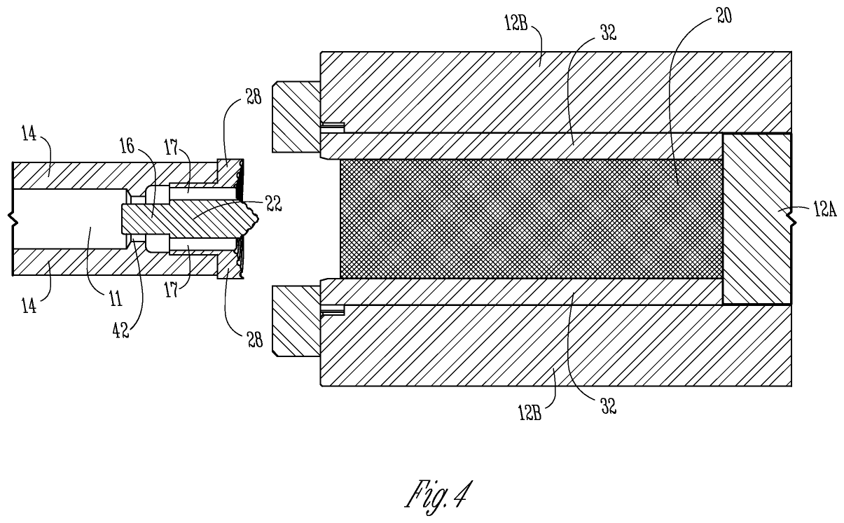

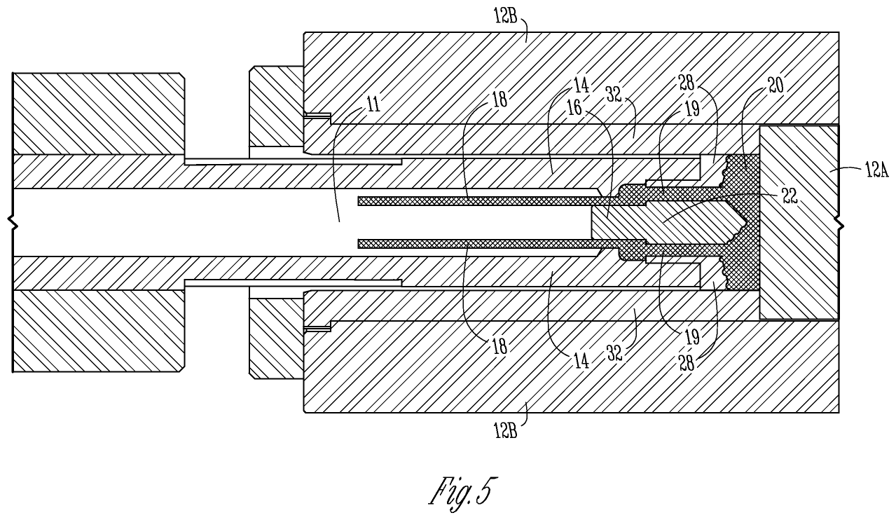

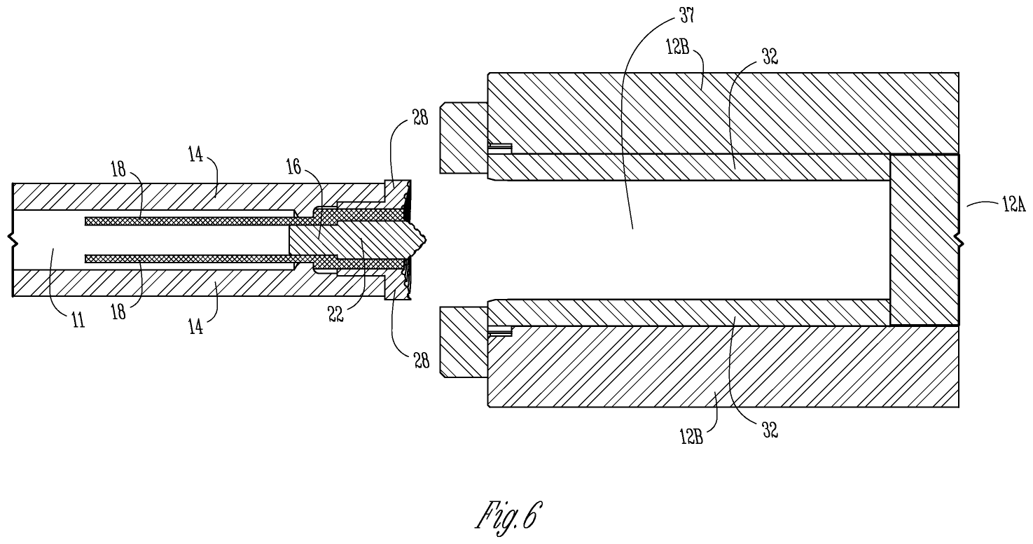

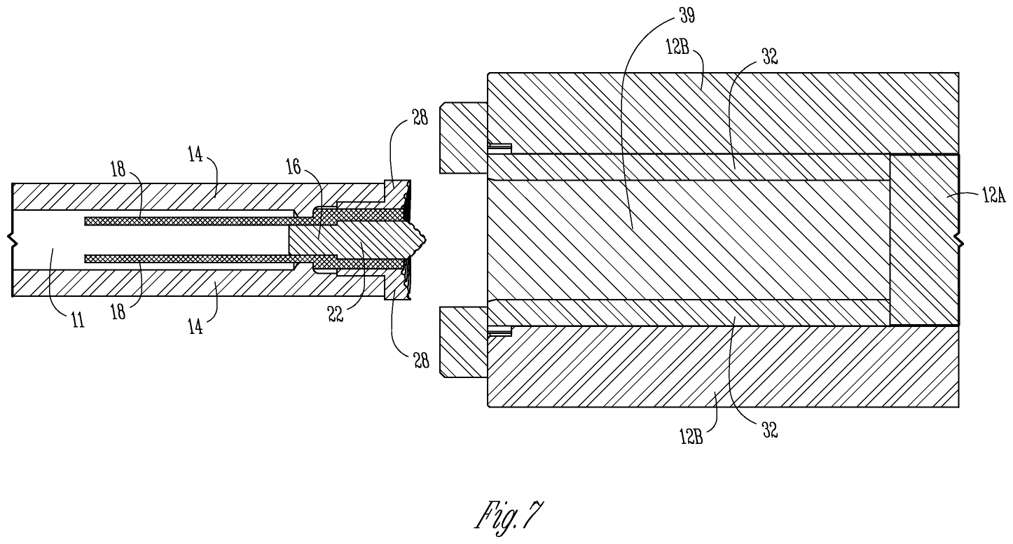

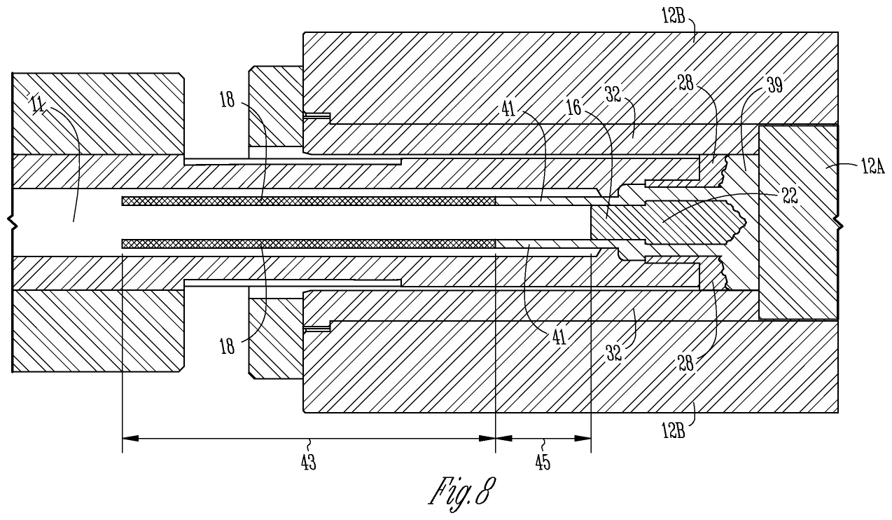

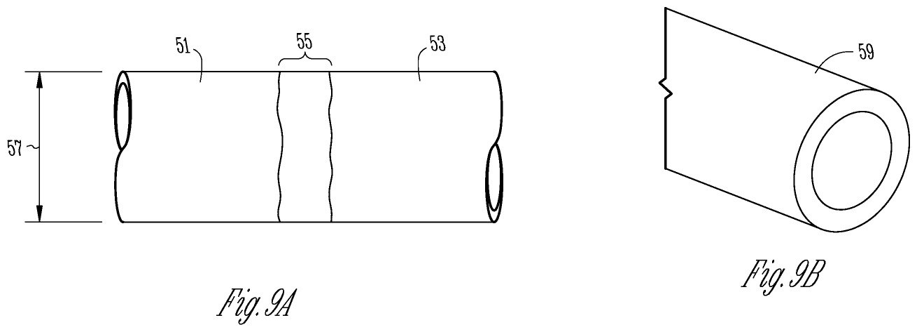

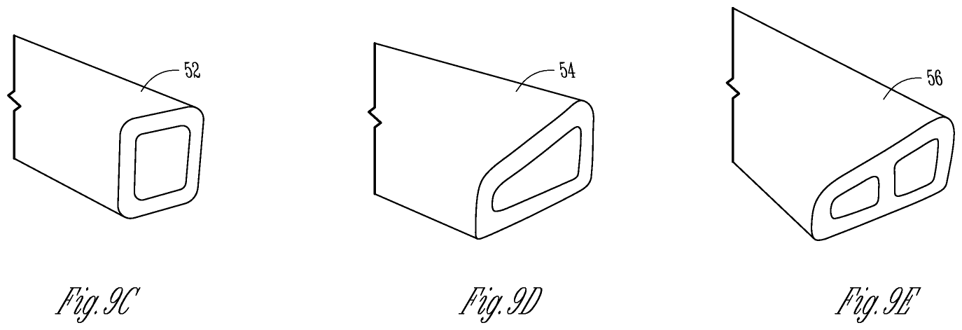

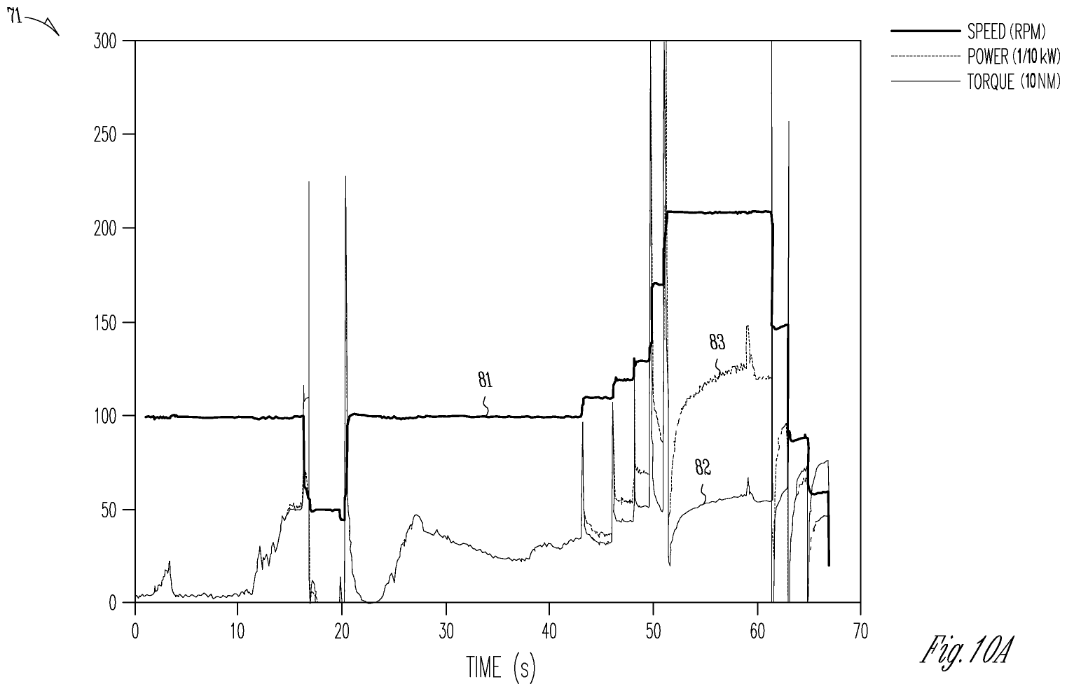

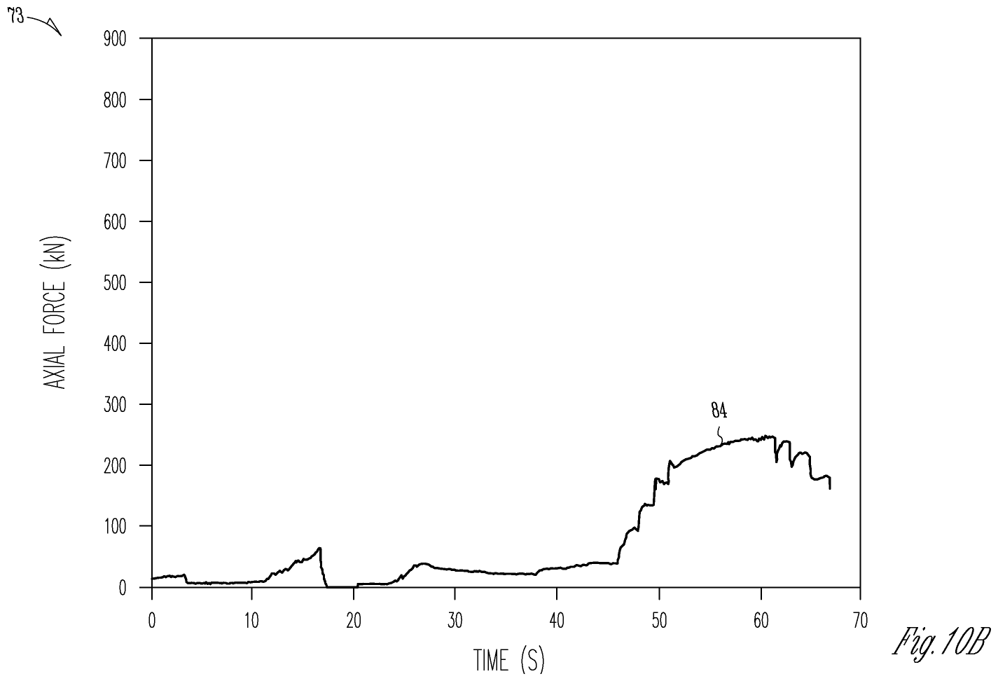

FIG. 1 illustrates, by way of example and not limitation, a system for extruding a structure having a hollow cross section. This can include using shear-assisted processing involving applying an axial compression force and a rotational shearing force. As shown in FIG. 1, a die assembly 10 can include a die face 28 that can be thrust against and into a billet material 20 (or vice versa). The die face 28 can include none, one, or more scrolls (e.g., a fluted or spiral topology defining surface contours that direct plasticized material inward as the die face 28 rotates relative to the billet material 20, illustrated further in FIG. 3A), the die face 28 can include other surface features, or it can even be flat. The billet material 20 can be held within a billet holder assembly 12 that includes a container base 12A and a container sidewall 12B.

A die tool 14 can be retained within die holder 21 and operably engaged with the billet material 20 to create a high shear region 26 of the billet 20 adjacent to die face 28. The rotation (illustrated by the rotating arrow) and the axial movement (illustrated by the double-sided arrow) of the die face 28 can induce shear to plasticize the billet material 20 at the interface between the die face 28 and the billet material 20. The plasticized material can flow in a specified direction. Additionally or alternatively, the billet material 20 may spin and the die face 28 can be pushed axially into the billet material 20 such as to provide a combination of shear and compressive forces at the interface between the billet material 20 and the die face 28. Regardless of which structure is rotated or rammed relative to the other, the combination of the axial and the rotating forces can plasticize the billet material 20 at the interface with the die face 28.

Flow of the plasticized material can then be directed, such as through an extrusion aperture, to another location, such as an internal portion 11 of the die assembly 10. The die face 28 can define a die face orifice 38. A longitudinal axis (or “central longitudinal axis”) 35 can be defined to extend through a center of the die face orifice 38. The die assembly 10 can rotate about the central longitudinal axis 35 to permit the die face 28 to engage the billet material 20. The plasticized material can reform to define an hollow-interior extruded structure 18 (also referred to as an “extrusion product” or an “extrudate”), such as can include one or more desired characteristics. Such characteristics can include grain structure or texture that are established using the extrusion through the die face orifice 38 or during down-stream processing such as controlled-temperature processing (e.g., quenching, annealing, or the like). Use of such down-stream processing is optional, and specified microstructure or other physical characteristics can be established using shear-assisted processing alone.

The mandrel 16 can be in close proximity to the die face 28 (or can even be a portion of the die assembly as shown in other examples herein). Together with a die face orifice 38 in the die face 28, the mandrel 16 can form an annular extrusion aperture (e.g., annular extrusion aperture 42 shown in FIG. 4 for ease of illustration) that the plasticized extrusion material is extruded through to form the extruded structure 18. The extrusion aperture can be formed when the mandrel 16 is extended through a die face orifice 38 in the die face 28. While the mandrel 16 is illustrated as protruding through a center of the billet 20, examples are not so limited. One such other example of the mandrel 16 being between two portions of the die face 28 is illustrated in FIG. 2.

FIG. 2 illustrates, by way of example and not limitation, a system for extruding a structure having a hollow cross section which can be round or non-round. The system includes a die assembly 10, die holder 21, a die shank 14, and a die face 28. The die assembly 10, the die shank 14, and the die face 28 can fixed to each other and rotate about a longitudinal axis 35. The system can include a container base 12A and a container sidewall 12B used to hold a billet material 20. As illustrated, a liner 32 can be in direct contact with the billet 20 and the container base 12A. However, examples are not so limited and the billet 20 can also be in direct contact with the container base 12A without a liner 32.

The die face 28 can be part of a porthole die 22 wherein the porthole die 22 includes a mandrel 16 that extends from the die face 28. The die face 28, porthole die 22, and mandrel 16 can move longitudinally along the longitudinal axis 35, either away from or toward the billet material 20. As the die face 28 approaches the billet material 20, the rotational shearing force and the axial extrusion force on the billet material 20 by the die face 28 can cause the billet material 20 to plasticize and be extruded through portholes 17 in the porthole die 22. The plasticized billet material extruded through the portholes 17 of the porthole die 22 can be extruded to surround the mandrel 16 behind the porthole die 22 and form an extruded structure, as will be further described below. The extruded structure can be extruded through an internal portion 11 of the die shank 14.

In an example, the base container 12A can be replaced with a stem or ram device that provides direct extrusion of the billet material 20. For example, a stem or ram device could be used to translate the billet material 20 axially toward the die face 28. In this example, the die face 28 may remain axially stationary. Alternatively, or additionally, the die face 28 could be translated toward the billet material 20.

FIGS. 3A-3B each illustrate, by way of example and not limitation, views of a porthole die with a modified scroll face and mandrel. FIG. 3A illustrates an oblique top view of the porthole die 22 showing the modified scroll face and FIG. 3B illustrates an oblique bottom view of the porthole die 22 showing the portholes and a mandrel. Grooves 13, 15 on the die face 28 of the porthole die 22 direct plasticized billet material toward the portholes 17. Plasticized billet material can then pass through the portholes 17 and across the mandrel 16. In this illustrative example, material flow can be separated into four distinct streams through each of the four portholes 17, as the billet material 20 and the porthole die 22 are forced against one another due to rotational and axial movement. As an illustration, the outer grooves 15 on the die face 28 can feed material radially inward toward the portholes 17, and inner grooves 13 on the die face 28 can feed material radially outward toward the portholes 17.

In this illustrative example, one groove 13 is feeding material radially outward toward each porthole 17 for a total of four outward flowing grooves. The outer grooves 15 on the die face 28 feed material radially inward toward the porthole 17. In this illustrative example, two grooves are feeding material radially inward toward each porthole 17 for a total of eight inward feeding grooves 15. In addition to these two sets of grooves, a perimeter groove 19 on the outer perimeter of the die 22, shown in FIG. 3B, is oriented counter to the die rotation so as to provide back pressure thereby minimizing material flash between the liner 32 (or, in the absence of a liner, the container sidewall 12B) and die assembly 10 during extrusion.

Referring to FIG. 3B, the porthole die 22 shows a series of full penetration of portholes 17. In use, streams of plasticized billet material directed by the inward 15 and outward 13 grooves described above pass through these porthole 17 and can then be recombined and flow around a mandrel 16 to create a desired cross section. In this way, the scrolled grooves 13, 15, 19 can be used to feed the portholes 17 during rotation to separate material flow of the feedstock (e.g., powder, flake, or billet) into distinct flow streams. This arrangement enables the formation of extruded products with hollow cross sections and, depending on the porthole die 22 configuration, non-circular interior or exterior profiles (or both). The threaded holes 123 can be used to attach the die face to the die shank.

FIG. 4 illustrates, by way of example and not limitation, a section view of a portion of a system including a die tool and a billet for extruding hollow cross section pieces. The section view of the portion of the system can be a section view from what is illustrated in FIG. 2. The portion of the system can include a die shank 14, and a die face 28. The die shank 14 and the die face 28 can be fixed to each other and rotate about a longitudinal axis (e.g., longitudinal axis 35 in FIG. 2). The portion of the system can include a container base 12A and a container sidewall 12B used to hold a billet material 20. As illustrated, a liner 32 can be in direct contact with the billet 20 and the container base 12A. However, examples are not so limited and the billet 20 can also be in direct contact with the container base 12A without a liner 32.

The die face 28 can be part of a porthole die (e.g., porthole die 22 in FIG. 3B) wherein the porthole die includes a mandrel 16 that extends outward from the die face 28. The die face 28 and mandrel 16 can move axially along the longitudinal axis, either away from or toward the billet material 20. As the die face 28 approaches the billet material 20, the rotational and axial motion can establish shear at an interface between the billet material 20 and the die face 28, causing the billet material 20 to plasticize and be extruded through portholes 17 in the porthole die 22. However, FIG. 4 illustrates the die face 28 separated from the billet material 20 and prior to the die face engaging the billet material 20.

FIG. 5 illustrates, by way of example and not limitation, a section view of a portion of a system including extruded structure 18 having a hollow cross section. By contrast with

FIG. 4, FIG. 5 shows the die face 28 engaging the billet material 20 and where the die face 28 has plasticized the billet material 20, such as nearly to the container base 12A. As is illustrated, a portion of the billet material 20 is not plasticized and a portion of extruded material 19 from plasticized billet material has extruded through the portholes 17 and in the porthole die 22. Extruded structure 18 can be formed from the portion of extruded material 19 to form a hollow cross section after it passes around the mandrel 16 and continues axially away from the die face 28 and porthole die 22. The mandrel 16 can be used to form a particular shape of the extruded structure 18. For example, the extruded structure 18 can be a circular cross section, or a non-circular cross section such as a trapezoidal profile. Some examples of possible cross sections are illustrated in FIGS. 9A-9E below.

As is described herein, the rotational shearing force and the axial extrusion force can be suspended or paused. In response to the suspension or pausing, the die face 28 can be moved away from the billet material 20, as is illustrated in FIG. 6, which includes extruded structure 18 and a billet container including a container sidewall 12B and a container base 12A. In an example where any billet material 20 remains, the billet material 20 can be removed from on or within the container sidewall 12B and the container base 12A leaving a vacant portion 37 between the two sides of the container sidewall 12B, as is illustrated in FIG. 6.

Further, examples may include leaving remaining billet material 20 on the container base 12A and/or within the container sidewall 12B. In the event the billet material 20 is left, a second rotational shearing force and a second axial extrusion force can be applied to the remaining billet material 20 by moving the die face 28 toward the remaining billet material 20 while applying the second rotational shearing force and the second axial extrusion force. In this example, the extruded structure 18 would include a first portion of extruded structure that was extruded prior to the suspension of the first rotational shearing force and the first axial extrusion force and a second portion of extruded structure that was extruded during the application of the second rotational shearing force and the second axial extrusion force (and subsequent to the suspension of forces). This first portion and second portion of extruded structure can be connected, sometimes seamlessly. The second rotational shearing force and the second axial extrusion force can be applied while the billet or a portion of the billet at the surface of the billet is at any temperature instance (e.g., ranging from below the melting to cooled down to production floor ambience temperature).

FIG. 7 illustrates, by way of example and not limitation, a section view of a portion of a system including extruded structure 18 and a second billet 39. The second billet 39 can be inserted into the vacant portion 37 (shown in FIG. 6) of the container sidewall 12B. The second billet 39 may be a same material as the first billet 20. The second billet 39 may be a different material than the first billet 20. In response to the second billet 39 being inserted into the container sidewall 12B and container base 12A, a second rotational shearing force and a second axial extrusion force can be applied to the second billet 39 by moving the die face 28 more toward the second billet material along a longitudinal axis (e.g., longitudinal axis 35 of FIG. 2).

Upon engagement of the die face 28 with a surface of the second billet material 39, the heating upon restart of the extrusion process (e.g., the heat created by the engagement of the die face 28 with the surface of the second billet material 39) can clear out the first extruded material from the die face 28, portholes 17, recombination areas, aperture, etc., by first heating the first billet material and then displacing the first billet material from these portions. At least a portion of the second billet material 39 can be plasticized and can begin to be extruded to replace the displaced first billet material and be fused to the first billet material. An example of a fused region is further described and illustrated in association with FIG. 9A below (e.g., fused region 55 in FIG. 9A). The second billet material 39 can then be extruded through portholes 17 of the porthole die 22, which is further illustrated in association with FIG. 8.

FIG. 8 illustrates, by way of example and not limitation, a system for extruding forming a hollow extruded structure from two billets. As is illustrated in FIG. 8, the die face 28 can move longitudinally along a longitudinal axis toward the container base 12A, thereby plasticizing a large portion of the second billet material 39. The second billet material 39 can be extruded using the porthole die 22 and associated mandrel 16. The plasticized second billet material can form a second extruded structure 41 that is connected to a first extruded structure 18. For example, the first extruded structure 18 at the outer surface or edge of the die face 28, as illustrated in FIG. 7, can be in contact with a surface of the second billet material 39 as the second rotational shearing force and the second axial extrusion force is initially applied to the surface of the second billet material 39. The initially plasticized second billet material 39 can then contact the first extruded structure 18 at the outer surface or edge of the die face 28, resulting in the first extruded structure 18 and the second extruded structure 41 being connected.

The first extruded structure 18 can be a length 43 that was extruded during the application of the first rotational shearing force and the first axial extrusion force. The second extruded structure 41 can be a length 45 that was extruded during the application of the second rotational shearing force and the second axial extrusion force. In this way, a suspension of a rotational shearing force and an axial extrusion force can be performed without needing to replace the die tool or the billet material getting stuck within the container sidewall 12B or container base 12A, thereby avoiding having to replace die tool parts or systems.

In some examples, suspension of the axial extrusion force and rotational shearing force may not necessarily require stopping of the spindle rotation itself. For example, the spindle of the die may be slowed down to prevent sufficient heating and/or engagement of the die with the billet may be stopped, thereby ending the affect of the axial extrusion force and the rotational shearing force. Further, suspension may include stopping or sufficiently reducing one or the other of the axial extrusion force or rotational shearing force, as long as sufficient heating or engagement of the die with the billet is prevented and therefore plasticization is prevented.

FIG. 9A illustrates an example of a shear-assisted extruded structure. The shear-assisted extruded structure can include a first portion 51 and a second portion 53. The first portion 51 and the second portion 53 may be from a same billet material. The first portion 51 and the second portion 53 may be from two separate billet materials (e.g., where a first billet material is removed subsequent to suspension of rotational shearing forces and axial extrusion forces and a second billet material is inserted). A third portion 55 between the first portion 51 and the second portion 53 can be a fused region 55 joining the first portion 51 and the second portion 53. The fused region 55 can be caused by suspension while extruding the first portion 51 and restarting or reinitiating during extrusion of the second portion 53, as was described above in association with FIGS. 7-8 above. For example, the first portion 51 can be initially extruded (e.g., extruded product 18) from a first billet material (e.g., first billet material 20) and a fused region can occur upon stop and restart of the extrusion as the last portion of the first billet material and a first portion of the second billet material (e.g., second billet material 39) is heated and plasticized, resulting in the fused region 55. A width 57 of the shear-assisted extruded structure can be determined based on an outer width of an opening around the mandrel 16. An inner width of the hollow extruded structure can be determined by the actual width of the mandrel 16.

FIG. 9B illustrates an example of a shear-assisted extruded structure 59. The shear-assisted extruded structure 59 can include a hollow, circular cross section. Additional cross-sectional profiles of extruded products may also be used, based on a shape of the mandrel 16. As an example, FIG. 9C illustrates an extruded structure 52 with an approximately square cross section, FIG. 9D illustrates an extruded structure 54 with an approximately trapezoidal profile or cross section, and FIG. 9E illustrates an extruded structure 56 with an approximately trapezoidal exterior cross section including an interior web support. Such cross-sectional variation can be achieved by using a particularly shaped mandrel and/or additional holes positioned such as to result in a plasticized extruded structure being formed around and/or through such mandrel 16 and holes, respectively.

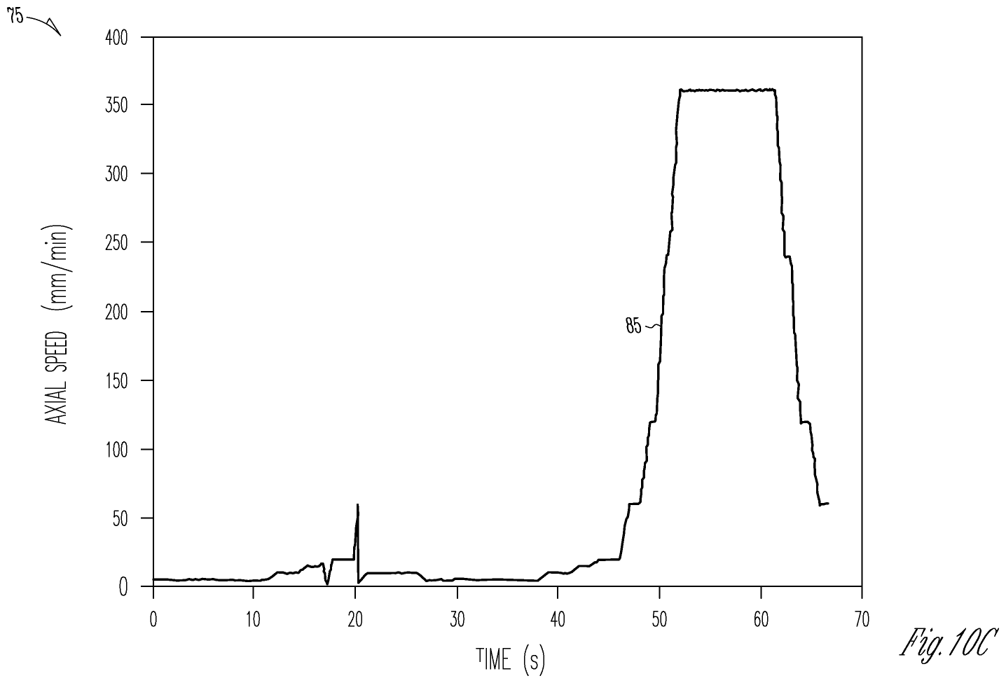

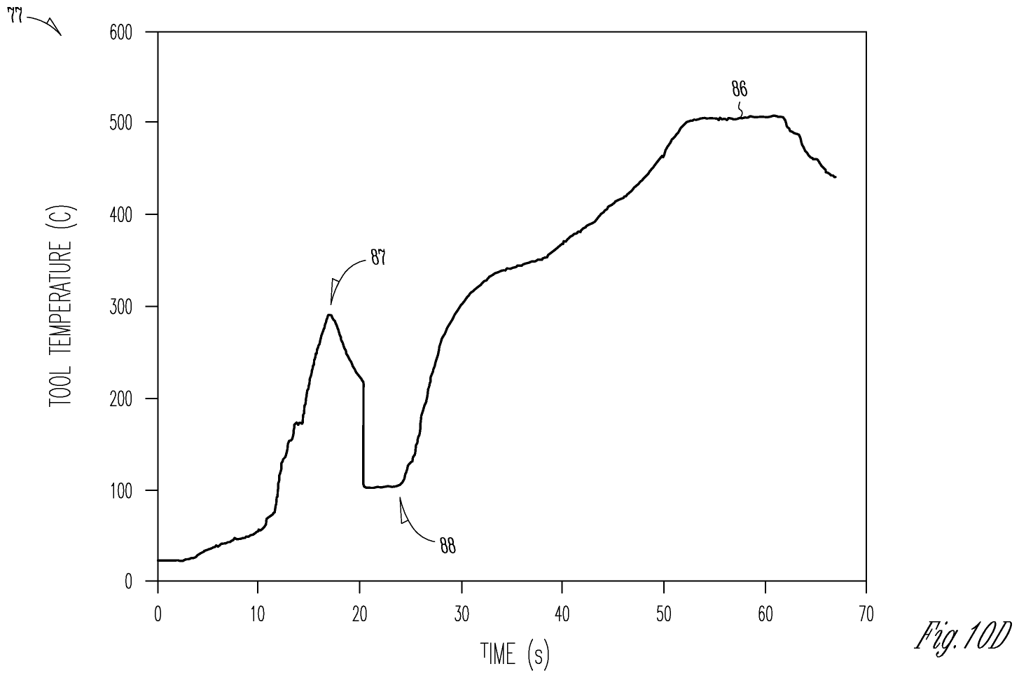

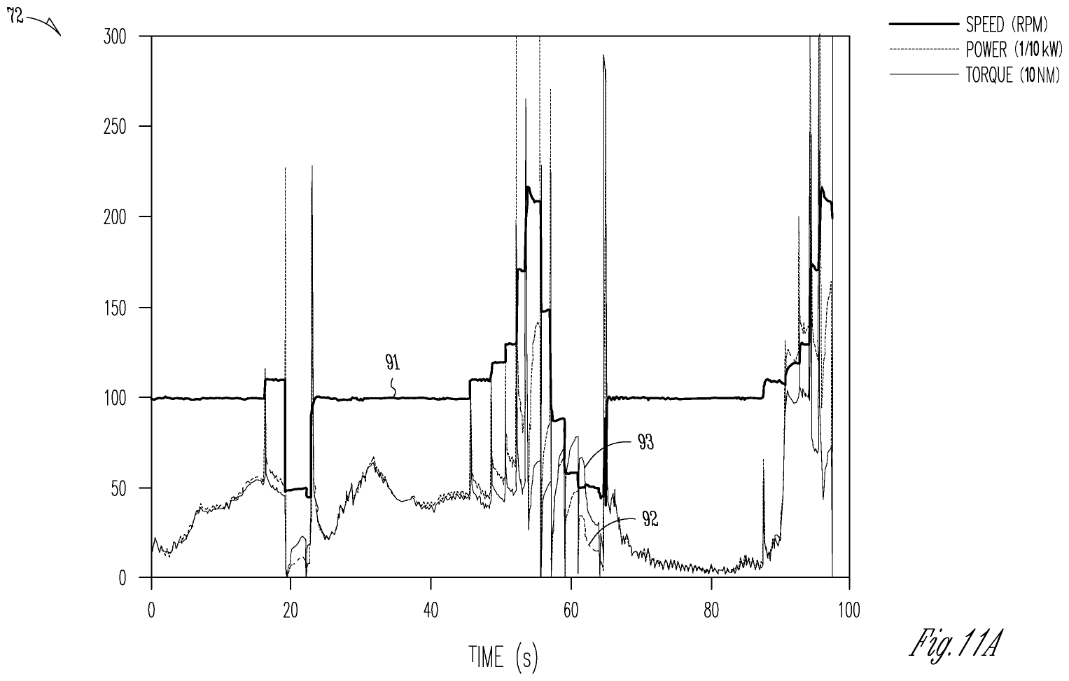

FIGS. 10A-10D each illustrate plots showing actual sample processing parameters versus time during suspension near the beginning of the extrusion process and restarting of an extrusion process. FIG. 10A illustrates, by way of example and not limitation, time-aligned plots 71 of spindle speed 81 (in revolutions per minute (RPMs)), spindle power 83 (in 0.1 kW), and torque 82 (in 10 Nm) of the rotational shearing force associated with the extrusion process. At approximately 17 seconds, the rotational shearing force and the axial extrusion force are suspended and the die is withdrawn, resulting in a shift of the parameters shown in FIGS. 10A-10D. The die and billet were allowed to cool for approximately 30 second (not shown and clipped out) at the 20 second mark. At approximately 20 seconds, the rotational shearing force and the axial extrusion force can be restarted or reinitiated. For example, the spindle speed 81 drops from 100 to 50 at approximately 17 seconds when the forces are suspended. The spindle torque 82 and the spindle power 83 can steadily increase between about 20 and 26 seconds.

FIG. 10B illustrates a graph 73 of axial force 84 over time, shown in kN. The axial force 84 drops at approximately 17 seconds as the forces are suspended and increases between 20 and 26 seconds as the extrusion restarts. Once the billet material comes up to temperature due to the rotational and axial forces, the axial force 84 levels out.

FIG. 10C illustrates, by way of example and not limitation, a graph 75 of axial speed 85, shown in mm/min. FIG. 10D illustrates, by way of example and not limitation, a graph 77 of tool temperature 86 over time during an extrusion process, shown in degrees Celsius. The tool temperature 86 steadily increases during the first rotational shearing force and first axial extrusion force prior to point 87 at 17 seconds, slowly cools between 17 and 20 second (with an additional 30 second of cooling omitted from the plot at the 20 second mark). Once the die 22 substantially engages billet material 39 at about 24 seconds the temperature at 86 again starts to rapidly rise again.

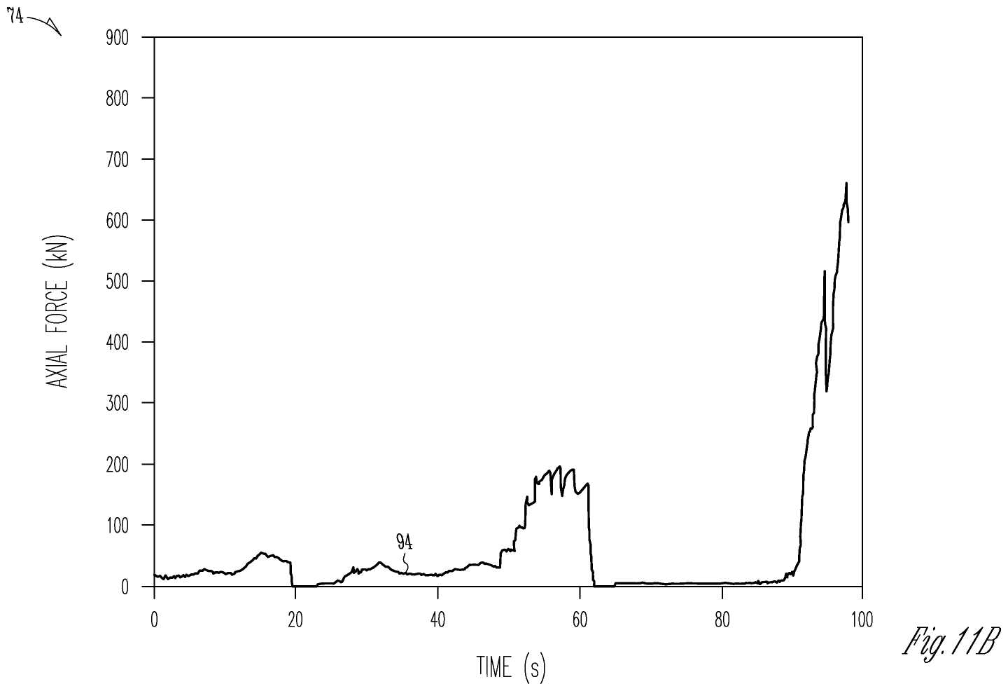

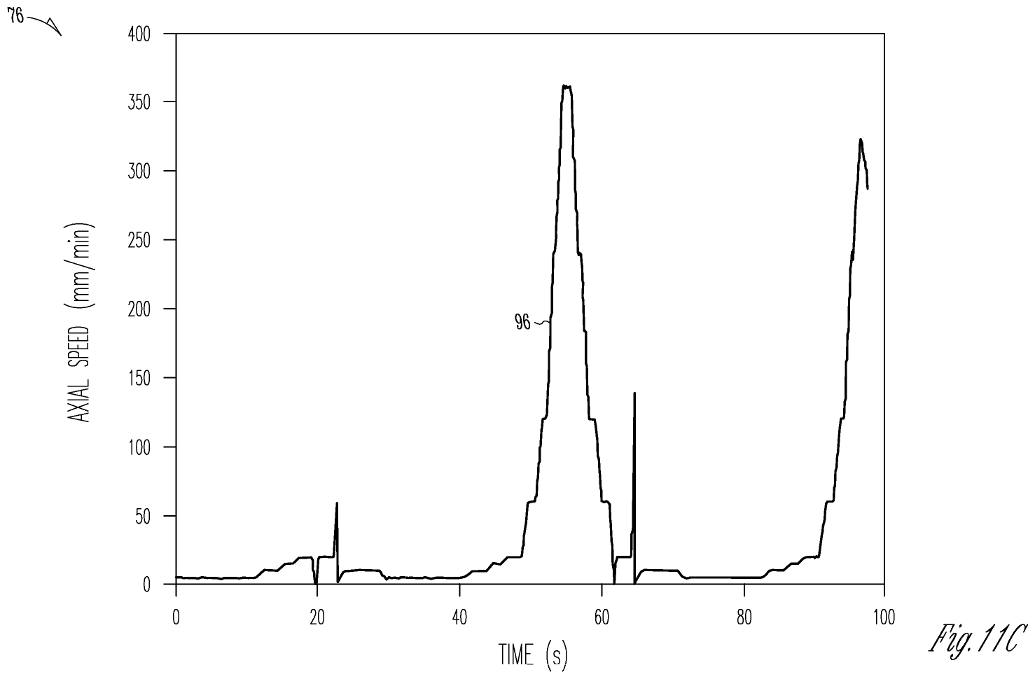

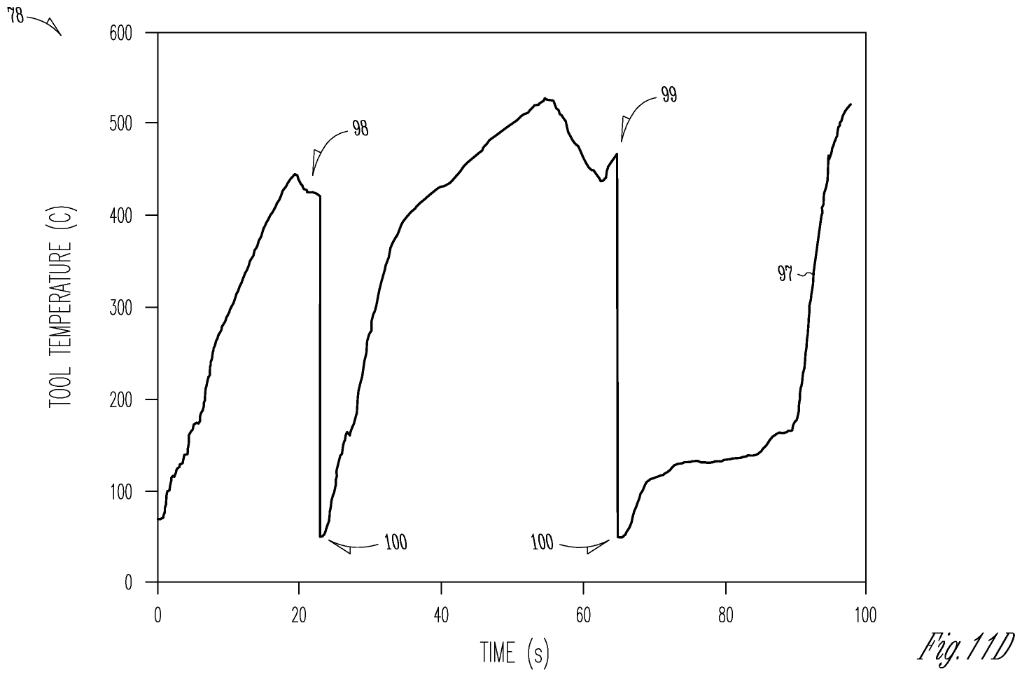

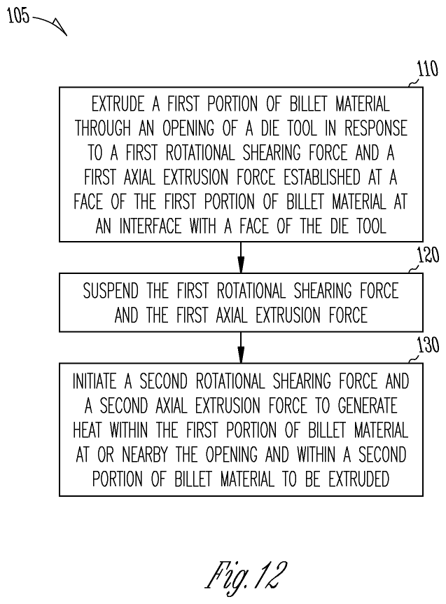

FIGS. 11A-11D each illustrate plots showing actual sample processing parameters versus time during two intentional suspensions and restarts of an extrusion process. The first suspension begins around 20 seconds, the first restart begins around 22 seconds, the second suspension starts around 62 seconds, and the second restart begins around 64 seconds. The first suspension demonstrates a suspension at slow axial feedrate, while the second suspension demonstrates a suspension at steady state under high axial feedrates. In both cases, the die and billet were allowed to cool for approximately 1 minute, which cooling process is clipped from the shown data. FIG. 11A illustrates, by way of example and not limitation, time-aligned plots 72 of spindle speed 91 (in revolutions per minute (RPMs)), spindle power 93 (in 0.1 kW), and torque 92 (in 10 Nm) of the rotational shearing force associated with the extrusion process. At approximately 20 seconds, the rotational shearing force and the axial extrusion force are be suspended, resulting in a shift of the parameters shown in FIGS. 11A-11D. Likewise, at approximately 22 seconds, the rotational shearing force and the axial extrusion force can be restarted. For example, the spindle speed 91 drops from 100 to 50 at approximately 20 seconds when the forces are suspended. The spindle torque 92 and the spindle power 93 can steadily increase from zero starting at around 22 seconds. Subsequently, at around 62 seconds, the spindle speed 91, the spindle torque 92, and the spindle power 93 all decrease until the rotational and axial forces are restarted at around 64 seconds, at which point the spindle speed 91 increases back to 100.

FIG. 11B illustrates a graph 74 of axial force 94 over time, shown in kN. The axial force 94 drops at approximately 20 and 62 seconds as the forces are suspended and increases at approximately 21 seconds, eventually increases at around 90 seconds, as the first and second restarts of extrusion occur. Once the billet material comes up to temperature due to the first and second rotational and axial forces, the axial force 94 levels out. FIG. 11C illustrates, by way of example and not limitation, a graph 76 of axial speed 95, shown in mm/min. The axial speed 95 steadily increases until a suspension and then begins to increase upon a restart. FIG. 11D illustrates, by way of example and not limitation, a graph 78 of tool temperature 96 over time during an extrusion process, shown in degrees Celsius. The tool temperature 96 steadily increases during the first rotational shearing force and first axial extrusion force prior to 20 (at point 98) and 62 (at point 99) seconds, then decreases to points 100 once suspension of the rotation and axial forces and a minute of cooling occurs, and increases around 22 and 64 seconds once the subsequent rotational shearing force and the subsequent axial extrusion force begins.

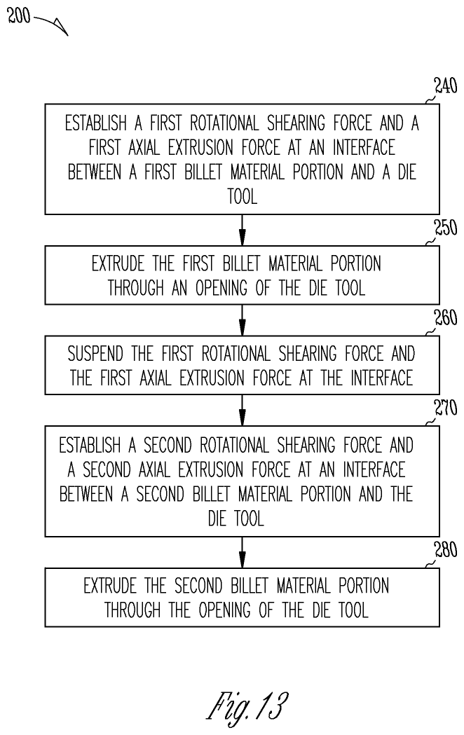

FIG. 12 illustrates, by way of example and not limitation, a method 105 of providing an interruptible shear-assisted extrusion. The method 105 may be carried out using an extrusion system such as the systems described in association with FIGS. 1 to 8. Various examples are illustrated in the figures above. One or more features from one or more of these examples may be combined to form other examples.

At 110, the method 105 can include extruding a first portion of billet material through an opening of a die tool in response to a first rotational shearing force and a first axial extrusion force established at a face of the first portion of billet material at an interface with a face of the die tool, the opening defining a shape to form an extruded structure. The shape may be a non-circular shape. The extruded structure may form a trapezoidal profile. The first portion of billet material may be a different material than the second portion of billet material. The first portion of billet material and the second portion of billet material may be a same material.

The first portion of billet material can be a first billet material and the second portion of billet material can be a separate second billet material housed by a container. The second billet material can be added to the container subsequent to the suspending of the first rotational shearing force and the first axial extrusion force. The die tool defines at least one aperture laterally spaced apart from a center portion of the die tool. The at least one aperture can be amongst multiple respective apertures arranged about the center portion of the die tool.

At 120, the method 105 can include suspending the first rotational shearing force and the first axial extrusion force. The first portion of billet material at or nearby the opening can cool after the suspending of the first rotational shearing force and the first axial extrusion force.

At 130, the method 105 can include initiating a second rotational shearing force and a second axial extrusion force to generate heat within the first portion of billet material at or nearby the opening and within a second portion of billet material to be extruded.

Initiating of the second rotational shearing force and the second axial extrusion force may not require clearing of the first portion of billet material at or nearby the opening from the opening or the face of the die tool beforehand. The suspending and the initiating may be performed without requiring retraction of the face of the die tool from the face of the first portion of billet material. The generated heat can plasticize the first portion of billet material at or nearby the opening and at least a portion of the second portion of billet material to be extruded, without forming a liquid phase.

The method 105 can include extruding a second portion of billet material through an opening of a die tool in response to the second rotational shearing force and the second axial extrusion force established at a face of the second portion of billet material at the interface with a face of the die tool. The extruded second portion of billet material can be fused with the extruded first portion of billet material by the generated heat.

FIG. 13 illustrates, by way of example and not limitation, a method 105 of providing an interruptible shear-assisted extrusion. The method 200 may be carried out using an extrusion system such as the systems described in association with FIGS. 1 to 8. Various examples are illustrated in the figures above. One or more features from one or more of these examples may be combined to form other examples.

At 240, the method 200 includes establishing a first rotational shearing force and a first axial extrusion force at an interface between a first billet material portion and a die tool. The first billet material portion can be a different material than the second billet material portion. The first billet material portion can be a same material as the second billet material portion. The die tool can include a die face that contacts the first billet material portion. The die tool can include a porthole die and the porthole die can include a mandrel.

At 250, the method 200 includes extruding the first billet material portion through an opening of the die tool. The opening can be at least one hole of a porthole die. The first billet material portion can extrude through the at least one hole of the porthole die and around the mandrel. The mandrel can determine a shape and/or profile of the extruded first billet material portion.

At 260, the method 200 includes suspending the first rotational shearing force and the first axial extrusion force at the interface. Suspension of the first rotational shearing and the first axial extrusion forces can cause the first billet material portion to cool and/or harden. A second billet material portion can be a subsequent portion of the first billet material portion. The second billet material portion can be a different billet inserted after removal of the first billet material portion.

At 270, the method 200 includes establishing a second rotational shearing force and a second axial extrusion force at an interface between a second billet material portion and the die tool. The second rotational shearing force and the second axial extrusion force can increase a temperature of the second billet material portion through generate heat. The generate heat can cause the second billet material portion to plasticize.

At 280, the method 200 includes extruding the second billet material portion through the opening of the die tool. An extruded second billet material portion can be fused with an extruded first billet material portion in response to heat generated by the second rotational shearing force and the second axial extrusion force, without melting the extruded first billet material portion or the extruded second billet material portion.

This process can help enable better strength, ductility, and corrosion resistance at the macroscopic level together with increased and better performance. This process can help reduce or eliminate the need for additional heating. The process can use any of a variety of forms of material including billet, powder, or flake without the need for extensive preparatory processes such as “steel canning”, billet preheating, de-gassing, de-canning, or the like. This arrangement can also help provide a methodology for performing other steps such as cladding, enhanced control for through wall thickness and other characteristics, joining of dissimilar materials and alloys, and may be used to provide feedstock materials for subsequent operations such as rolling.

As discussed above, ShAPE generally involves engagement of a die tool with a billet material as a feedstock to produce an extrudate. For example, the die tool can use spiral grooves on a die face to feed material inward through a die and around a mandrel that is traveling in the same direction as the extrudate. As such, a much larger outer diameter and extrusion ratio are possible as compared to other approaches, the material has a controlled wall thickness, the extrudate is free to push off the mandrel as in other extrusion techniques, and the extrudate length is limited only by feedstock volume.

Accordingly, ShAPE can be scaled to suit higher-volume production.

The method examples described herein may be machine or computer-implemented at least in part. Some examples may include a computer-readable medium or machine-readable medium encoded with instructions operable to configure an electronic device or system to perform methods as described in the above examples. An implementation of such methods may include code, such as microcode, assembly language code, a higher-level language code, or the like. Such code may include computer readable instructions for performing various methods. The code may form portions of computer program products. Further, the code may be tangibly stored on one or more volatile or non-volatile computer-readable media during execution or at other times.

An example (e.g., “Example 1”) of a method can include extruding a first portion of billet material through an opening of a die tool in response to a first rotational shearing force and a first axial extrusion force established at a face of the first portion of billet material at an interface with a face of the die tool, the opening defining a shape to form an extruded structure; suspending the first rotational shearing force and the first axial extrusion force; and initiating a second rotational shearing force and a second axial extrusion force to generate heat within the first portion of billet material at or nearby the opening and within a second portion of billet material to be extruded.

In Example 2, the subject matter of Example 1 optionally includes wherein the first portion of billet material comprises a different material than the second portion of billet material.

In Example 3, the subject matter of any one or more of Examples 1-2 optionally include wherein the initiating of the second rotational shearing force and the second axial extrusion force does not require clearing of the first portion of billet material at or nearby the opening from the opening or the face of the die tool beforehand.

In Example 4, the subject matter of Example 3 optionally includes wherein the first portion of billet material is a first billet material and the second portion of billet material is a separate second billet material housed by a container.

In Example 5, the subject matter of Example 4 optionally includes wherein the second billet material is added to the container subsequent to the suspending of the first rotational shearing force and the first axial extrusion force.

In Example 6, the subject matter of any one or more of Examples 1-5 optionally include wherein the suspending and the initiating are performed without requiring retraction of the face of the die tool from the face of the first portion of billet material.

In Example 7, the subject matter of any one or more of Examples 1-6 optionally include wherein the first portion of billet material and the second portion of billet material comprise a same material.

In Example 8, the subject matter of any one or more of Examples 1-7 optionally include wherein the extruded shape is a non-circular shape.

In Example 9, the subject matter of any one or more of Examples 1-8 optionally include wherein the extruded structure forms an approximately trapezoidal profile.

In Example 10, the subject matter of any one or more of Examples 1-9 optionally include extruding a second portion of billet material through an opening of a die tool in response to the second rotational shearing force and the second axial extrusion force established at a face of the second portion of billet material at the interface with a face of the die tool.

In Example 11, the subject matter of Example 10 optionally includes wherein the extruded second portion of billet material is fused with the extruded first portion of billet material by the generated heat or pressure.

In Example 12, the subject matter of any one or more of Examples 1-11 optionally include wherein the generated heat plasticizes the first portion of billet material at or nearby the opening and at least a portion of the second portion of billet material to be extruded, without forming a liquid phase.

In Example 13, the subject matter of any one or more of Examples 1-12 optionally include wherein: the die tool defines at least one aperture laterally spaced apart from a center portion of the die tool; and the at least one aperture is amongst multiple respective apertures arranged about the center portion of the die tool.

In Example 14, the subject matter of any one or more of Examples 1-13 optionally include wherein the die tool or first portion of billet material at or nearby the opening cools after the suspending of the first rotational shearing force and the first axial extrusion force.

Example 15 is a method for shear-assisted extrusion, the method comprising: establishing a first rotational shearing force and a first axial extrusion force at an interface between a first billet material portion and a die tool; extruding the first billet material portion through an opening of the die tool; suspending the first rotational shearing force and the first axial extrusion force at the interface; establishing a second rotational shearing force and a second axial extrusion force at an interface between a second billet material portion and the die tool; extruding the second billet material portion through the opening of the die tool; and wherein an extruded second billet material portion is fused with an extruded first billet material portion in response to heat or pressure generated by the second rotational shearing force and the second axial extrusion force, without melting the extruded first billet material portion or the extruded second billet material portion.

In Example 16, the subject matter of Example 15 optionally includes wherein the first billet material portion comprises a different material than the second billet material portion.

In Example 17, the subject matter of any one or more of Examples 15-16 optionally include wherein the first billet material portion and the second billet material portion comprise a same material.

Example 18 is a method for shear-assisted extrusion, the method comprising: extruding a feedstock material through an opening of a die tool in response to a first rotational shearing force and a first axial extrusion force established at an interface between the feedstock material and a face of the die tool, the opening defining a shape to form an extruded structure; suspending the first rotational shearing force and the first axial extrusion force; and initiating a second rotational shearing force and a second axial extrusion force to generate heat within the feedstock material at or nearby the opening.

In Example 19, the subject matter of Example 18 optionally includes wherein the initiating of the second rotational shearing force and the second axial extrusion force does not require clearing of any portion of the feedstock material at or nearby the opening from the opening or the face of the die tool beforehand.

In Example 20, the subject matter of any one or more of Examples 18-19 optionally include wherein the suspending and the initiating are performed without requiring retraction of the face of the die tool from a face of the feedstock material.

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The above detailed description is intended to be illustrative, and not restrictive. The scope of the disclosure should, therefore, be determined with references to the appended claims, along with the full scope of equivalents to which such claims are entitled.

What is claimed:

1. A method for shear-assisted extrusion, the method comprising:
extruding a first portion of billet material through an opening of a die tool in response to a first rotational shearing force and a first axial extrusion force established at a face of the first portion of billet material at an interface with a face of the die tool, the opening defining a shape to form an extruded structure;
suspending the first rotational shearing force and the first axial extrusion force; and
initiating a second rotational shearing force and a second axial extrusion force to generate heat within the first portion of billet material at or nearby the opening and within a second portion of billet material to be extruded.

2. The method of claim 1, wherein the first portion of billet material comprises a different material than the second portion of billet material.

3. The method of claim 1, wherein the initiating of the second rotational shearing force and the second axial extrusion force does not require clearing of the first portion of billet material at or nearby the opening from the opening or the face of the die tool beforehand.

4. The method of claim 3, wherein the first portion of billet material is a first billet material and the second portion of billet material is a separate second billet material housed by a container.

5. The method of claim 4, wherein the second billet material is added to the container subsequent to the suspending of the first rotational shearing force and the first axial extrusion force.

6. The method of claim 1, wherein the suspending and the initiating are performed without requiring retraction of the face of the die tool from the face of the first portion of billet material.

7. The method of claim 1, wherein the first portion of billet material and the second portion of billet material comprise a same material.

8. The method of claim 1, wherein the extruded shape is a non-circular shape.

9. The method of claim 1, wherein the extruded structure forms an approximately trapezoidal profile.

10. The method of claim 1, comprising extruding a second portion of billet material through an opening of a die tool in response to the second rotational shearing force and the second axial extrusion force established at a face of the second portion of billet material at the interface with a face of the die tool.

11. The method of claim 10, wherein the extruded second portion of billet material is fused with the extruded first portion of billet material by the generated heat or pressure.

12. The method of claim 1, wherein the generated heat plasticizes the first portion of billet material at or nearby the opening and at least a portion of the second portion of billet material to be extruded, without forming a liquid phase.

13. The method of claim 1, wherein:
the die tool defines at least one aperture laterally spaced apart from a center portion of the die tool; and
the at least one aperture is amongst multiple respective apertures arranged about the center portion of the die tool.

14. The method of claim 1, wherein the die tool or first portion of billet material at or nearby the opening cools after the suspending of the first rotational shearing force and the first axial extrusion force.

15. A method for shear-assisted extrusion, the method comprising:
establishing a first rotational shearing force and a first axial extrusion force at an interface between a first billet material portion and a die tool;
extruding the first billet material portion through an opening of the die tool;
suspending the first rotational shearing force and the first axial extrusion force at the interface;
establishing a second rotational shearing force and a second axial extrusion force at an interface between a second billet material portion and the die tool;
extruding the second billet material portion through the opening of the die tool; and
wherein an extruded second billet material portion is fused with an extruded first billet material portion in response to heat or pressure generated by the second rotational shearing force and the second axial extrusion force, without melting the extruded first billet material portion or the extruded second billet material portion.

16. The method of claim 15, wherein the first billet material portion comprises a different material than the second billet material portion.

17. The method of claim 15, wherein the first billet material portion and the second billet material portion comprise a same material.

18. A method for shear-assisted extrusion, the method comprising:
extruding a feedstock material through an opening of a die tool in response to a first rotational shearing force and a first axial extrusion force established at an interface between the feedstock material and a face of the die tool, the opening defining a shape to form an extruded structure;
suspending the first rotational shearing force and the first axial extrusion force; and
initiating a second rotational shearing force and a second axial extrusion force to generate heat within the feedstock material at or nearby the opening.

19. The method of claim 18, wherein the initiating of the second rotational shearing force and the second axial extrusion force does not require clearing of any portion of the feedstock material at or nearby the opening from the opening or the face of the die tool beforehand.

20. The method of claim 18, wherein the suspending and the initiating are performed without requiring retraction of the face of the die tool from a face of the feedstock material.
